(19) United States
(12) Patent Application Publication
(10) Pub. No.: US 2023/0388987 A1
(43) Pub. Date: Nov. 30, 2023

(54) FREQUENCY CHANGE DURING CONNECTION EVENT

(71) Applicant: TEXAS INSTRUMENTS INCORPORATED, Dallas, TX (US)

(72) Inventors: Yaron Alpert, HOD-HASHARON (IL); Yaniv Weizman, TEL-AVIV JAFFA (IL); Maxim Altshul, KADIMA (IL)

(21) Appl. No.: 17/828,225

(22) Filed: May 31, 2022

(51) Int. Cl. H04W 72/04; H04W 76/14

(52) U.S. Cl. CPC H04W 72/0453; H04W 76/14; H04W 72/0406

(57) ABSTRACT

A method includes sending, by a first node to a second node during a first connection event, a request to change a current operation frequency, wherein the request is encoded in a first operation frequency. The method also includes sending, by the first node to the second node during the first connection event, a first packet encoded in a second operation frequency, where second operation frequency is different from the first operation frequency.

### BACKGROUND

A Bluetooth Low Energy (BLE) connection event occurs when two devices transfer data over a BLE communication channel. During a first connection event at a pre-defined operation frequency/channel, a central node sends a first packet to a peripheral node. After receiving the first packet, the peripheral node sends a second packet to the central node. The first connection event continues with alternating transfers between the two nodes until the devices terminate the first connection event, until the two nodes have no more data to transfer, or until a maximum time duration for the connection event has elapsed. After the end of the first connection event, the nodes may begin communicating again during a second connection event at a different pre-defined operation frequency/channel.

### SUMMARY

In some examples, a method includes sending, by a first node to a second node during a first connection event, a request to change a current operation frequency, wherein the request is encoded in a first operation frequency. The method also includes sending, by the first node to the second node during the first connection event, a first packet encoded in a second operation frequency, where second operation frequency is different from the first operation frequency.

In further examples, a device includes transceiver circuitry and processing circuitry. The processing circuitry is configured to generate a request to change a current operation frequency during a first connection event. In addition, the processing circuitry is configured to cause the transceiver circuitry to send the request encoded in a first operation frequency. The processing circuitry is also configured to generate a first packet after causing the transceiver circuitry to send the request. The processing circuitry is further configured to cause the transceiver circuitry to send, during the first connection event, the first packet encoded in a second operation frequency, where the second operation frequency is different from the first operation frequency.

In yet further examples, non-transitory computer-readable medium having executable instructions stored thereon, configured to be executable by processing circuitry for causing the processing circuitry to generate a request to change a current operation frequency during a first connection event. When executed, the instructions also cause the processing circuitry to cause transceiver circuitry to send the request encoded in a first operation frequency. The instructions, when executed, further cause the processing circuitry to generate a first packet after causing the transceiver circuitry to send the request. In addition, when executed, the instructions cause the transceiver circuitry to send, during the first connection event, the first packet encoded in a second operation frequency, where the second operation frequency is different from the first operation frequency.

### BRIEF DESCRIPTION OF THE DRAWINGS

Features of the present invention may be understood from the following detailed description and the accompanying drawings. In that regard:

FIG. 1 is a conceptual block diagram of a central node communicating with a peripheral node according to some aspects of the present disclosure.

FIG. 2 is a timing diagram of two connection events.

FIG. 3 is a timing diagram of four connection events during which a node experiences noise.

FIGS. 4-8 are timing diagrams that include a request to change frequencies during a connection event according to some aspects of the present disclosure.

FIGS. 9 and 10 are flow diagrams of methods of changing frequencies during a connection event according to some aspects of the present disclosure.

FIGS. 11 and 12 are flow diagrams of methods of scheduling a transfer to a new operation frequency in a subsequent connection event according to some aspects of the present disclosure.

FIG. 13 is a flow diagram of method of extending the duration of a connection event according to some aspects of the present disclosure.

### DETAILED DESCRIPTION

Specific examples are described below in detail with reference to the accompanying figures. It is understood that these examples are not intended to be limiting, and unless otherwise noted, no feature is required for any particular example.

Two electronic devices may communicate with each other using a technical standard that provides for connection events involving the exchange of packets between the devices. The exchange of packets between the devices during a single connection event may occur within a single pre-defined operation frequency/channel. In other words, according to the technical standard, each device may encode packets in a single operation frequency for the duration of the connection event without transferring to another operation frequency.

If the nodes experience jamming, noise, or interference on an operation frequency during a connection event, any retransmission of a packet will occur in the same operation frequency. The jammer may jam fewer than all of the available operation frequency (e.g., frequency selective fading), while other available operation frequency are unjammed. According to the technical standard, the nodes will communicate on the same operation frequency throughout the connection event, even when faced with a high loss rate or a high retransmission rate. Thus, the performance of the nodes may suffer because of the inability of the nodes to hop to another operation frequency before the end of the connection event.

In accordance with the techniques of this disclosure, one of the nodes may issue a request to switch into a new operation frequency before the end of the current connection event. By transferring to another operation frequency, the nodes may be able to avoid the interference on one channel by quickly transferring to another operation frequency. A fast switch to another operation frequency may improve throughput, increase the immunity to jamming and interference, and reduce latency and response time. Of course, these advantages are merely examples, and no advantage is required for any particular embodiment.

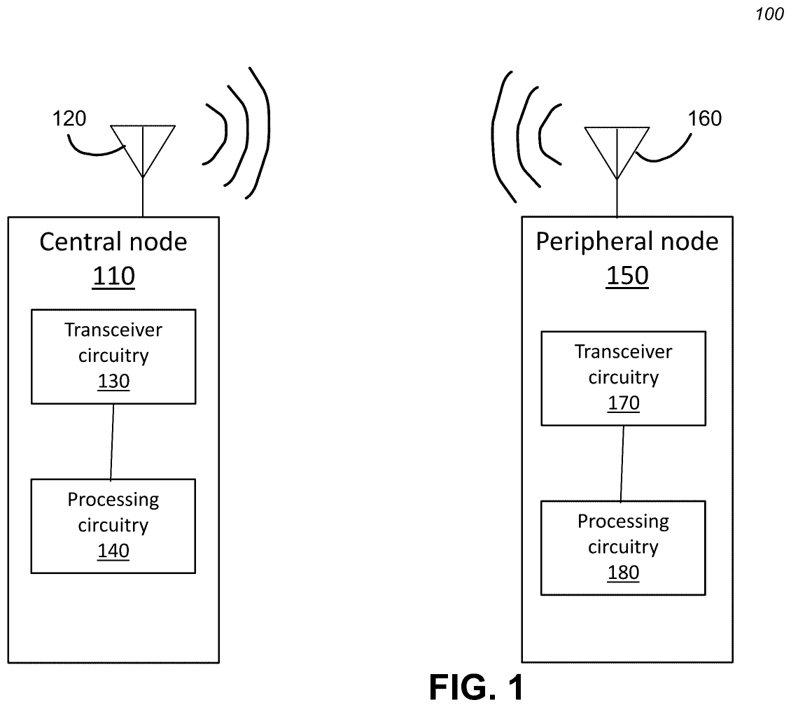

Examples of frequency switching during a connection event are described with reference to the figures below. In that regard, FIG. 1 is a conceptual block diagram of a central node 110 communicating with a peripheral node 150 according to some aspects of the present disclosure. System 100 includes central node 110 and peripheral node 150, each of which includes antenna 120 or 160, transceiver circuitry 130 or 170, and processing circuitry 140 or 180. Central node 110 and peripheral node 150 are communicatively coupled via wireless communications, such as via a short-range technical standard (e.g., Bluetooth Low Energy® (BLE) as specified by the Bluetooth Special Interest group). Additional example details of BLE can be found in commonly assigned U.S. Patent Application Publication No. 2020/0187010, entitled “Secure Localization in Wireless Networks,” filed on Dec. 11, 2018, and U.S. Pat. No. 10,225,873, entitled “System and Method for Peripheral Initiated Host Arbitration,” filed on Feb. 18, 2016 and issued on Mar. 5, 2019, each of which is incorporated by reference in its entirety.

In at least some examples, processing circuitry 140 constructs a packet for transmission to the peripheral node 150. Processing circuitry 140 may be configured to construct the packet to include a header, a payload, and an error correction code. Processing circuitry 140 then causes transceiver circuitry 130 to transmit the packet via antenna 120 to peripheral node 150. Transceiver circuitry 130 and/or processing circuitry 140 may be configured to encode the packet in an operation frequency based on a pre-defined operation frequency set (i.e. channels set). In the example of BLE communication, transceiver circuitry 130 and/or processing circuitry 140 may be configured to encode packets by using phase shift keying (PSK) such as differential PSK to modulate a carrier signal.

Peripheral node 150 tunes into the pre-defined operation frequency in order to receive the packet at antenna 160, and transceiver circuitry 170 filters and/or amplifies the signal encoding the packet. Transceiver circuitry 170 and/or processing circuitry 180 may be configured to decode the signal encoding the packet and store the data in the packet. Transceiver circuitry 170 and processing circuitry 180 may be configured to perform the same steps as transceiver circuitry 130 and processing circuitry 140 in generating and transmitting packets. The same general steps may be undertaken by processing circuitry 140 and 180 and transceiver circuitry 130 and 170 to generate and transmit the requests described herein. As examples, the link layer or the air access control in processing circuitry 140 or 180 may be configured to generate, for transmission by transceiver circuitry 130 or 170, a request to change the current operation frequency. The frequency change request may be transparent to the host and to the application running on node 110 or 150. The frequency change request can be issued by processing circuitry 140 or 180 as a response to a short or long channel quality assessment.

Nodes 110 and 150 may be communicatively coupled via a wireless channel at pre-defined operation frequency, which nodes 110 and 150 may change at the beginning of every connection event. Nodes 110 and 150 can exchange packets by encoded data in the operation frequency during connection events. In examples of BLE communication, central node 110 may be configured to initiate each connection event by sending a packet to peripheral node 150. The connection event may continue with nodes 110 and 150 exchanging packets until the connection event ends. Once nodes 110 and 150 have reached the end of the duration of the connection event, nodes 110 and 150 may cease exchanging packets and initialize the next connection event at a pre-defined time. Alternatively, nodes 110 and 150 can voluntarily terminate the exchange of packets before the end of the connection event. After this early termination, nodes 110 and 150 may be configured to refrain from communicating during the remaining duration of the connection event until nodes 110 and 150 initialize the next connection event.

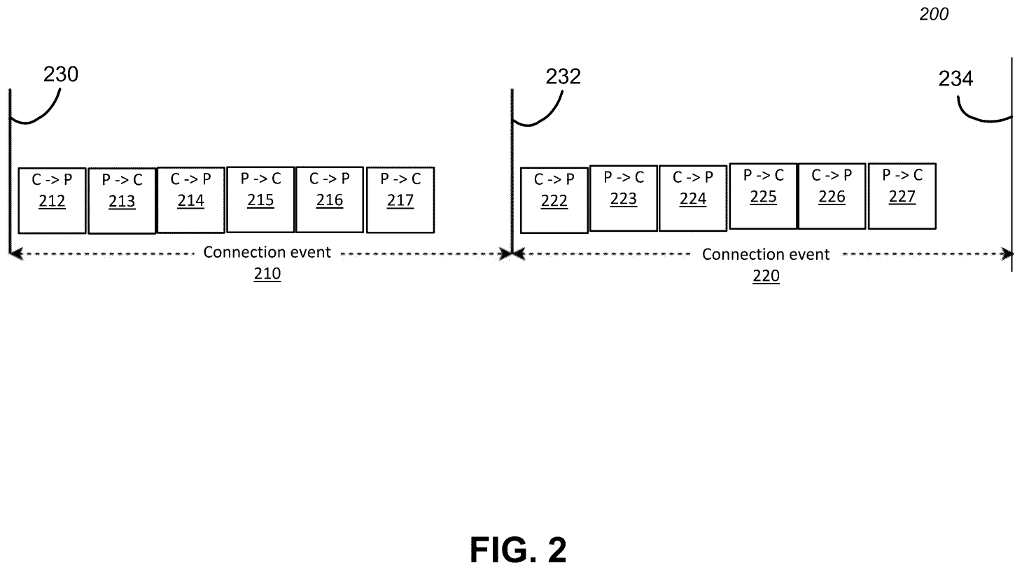

FIG. 2 is a timing diagram 200 of two connection events 210 and 220. Connection event 210 starts at time 230 and ends at time 232 at a pre-defined operation frequency, while connection event 220 starts at time 232 and ends at time 234 at different pre-defined operation frequency. Each of connection events 210 and 220 may have a duration known as a connection interval, which may be a preset duration. In some examples, each connection event may have variable duration bounded by a maximum allowable duration.

During connection event 210, the central and peripheral nodes exchange packets 212-217. During connection event 220, the central and peripheral nodes exchange packets 222-227. In some examples, the duration of each packet (e.g., the time between the beginning of packet 212 and the beginning of packet 213) is approximately one hundred and fifty microseconds.

In the example shown in timing diagram 200, the central and peripheral nodes alternate between transmitting and receiving. For example, during connection event 210, the transmission of packets 212, 214, and 216 by the central node is interleaved with the transmission of packets 213, 215, and 217 by the peripheral node. During connection event 220, the transmission of packets 222, 224, and 226 by the central node is interleaved with the transmission of packets 223, 225, and 227 by the peripheral node. The central node initiates both of connection events 210 and 220 by transmitting packets 212 and 222, but the peripheral node may be configured to initiate a connection event by transmitting a packet.

In some examples, the central and peripheral nodes may exchange packets 212-217 within a first operation frequency and may exchange packets 222-227 within a second operation frequency that is different from the first operation frequency. The central and peripheral nodes may be configured to select the operation frequency for each connection event based on a pre-defined channel set and/or by negotiating the new operation frequency. The pre-defined channel set may be an ordered list of channels that the nodes use for each new connection event. In the example of BLE, there are up to forty channels (e.g., potential operation frequencies), with center-on-center spacing of two megahertz. Additional example details of BLE can be found in version 5.3 of the Bluetooth Core Specification, published on Jul. 13, 2021, which is incorporated by reference in its entirety.

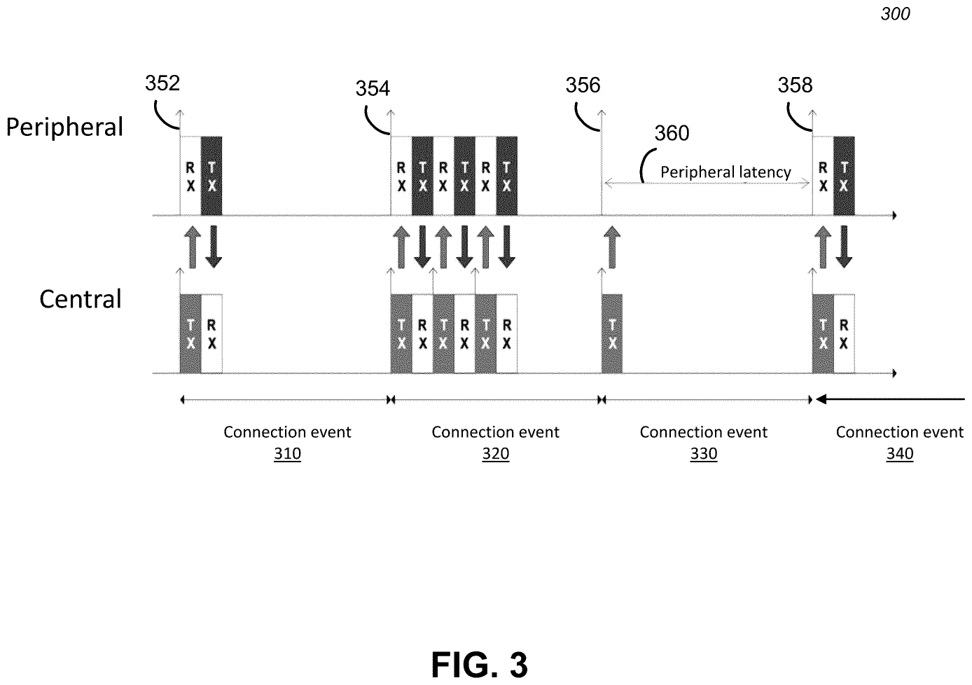

FIG. 3 is a timing diagram 300 of four connection events 310, 320, 330, and 340 during which a node experiences noise. In some examples, the exchange of packets during each of connection events 310, 320, 330, and 340 occurs at a different operation frequency. The nodes may exchange packets during connection event 310 at a first operation frequency, and the nodes may exchange packets during connection event 320 at a second operation frequency that is different from the first operation frequency. In addition, the nodes may exchange packets during connection event 330 at a third operation frequency that is different from the first and second operation frequencies. The nodes may also exchange packets during connection event 340 at a fourth operation frequency that is different from the first, second, and third operation frequencies. During connection event 330, the peripheral node does not receive a transmission from the central node because of, for example, noise or jamming. The operation frequency used for communication during connection event 330 is experiencing this noise or jamming, while other available operation frequencies may be relatively noise-free. If the nodes are not configured to change operation frequency inside of connection event 330, the node may have to wait until connection event 340 when a regular operation frequency transition occurs.

This situation is shown in timing diagram 300, when the peripheral node waits during latency 360 until the beginning of connection event 340. The peripheral node does not receive the packet transmitted by the central node at the beginning of connection event 330. As a result, the peripheral node does not transmit a packet to the central node during the connection event 330. Instead, the peripheral node waits until the beginning of connection event 340 when the central node will transmit a packet encoded in a new operation frequency. The node implement this retry mechanism by waiting to attempt communication at the beginning of connection event 340, either on the channel used in connection event 330 or on a different channel. The nodes do not communicate during the waiting period shown in FIG. 3 as latency 360.

Returning to the beginning of timing diagram 300, connection event 310 starts at time 352 and ends at time 354, connection event 320 starts at time 354 and ends at time 356, connection event 330 starts at time 356 and ends at time 358, and connection event 340 starts at time 358. The central and peripheral nodes exchange two packets during connection event 310, six packets during connection event 320, one packet during connection event 330, and two packets during connection event 340. In the example shown in timing diagram 300, the central node initiates each connection event by transmitting. A technical standard may establish that the central node initiates communication during each connection event, or the technical standard may allow for the peripheral node to initiate communication under some circumstances.

Each of connection events 310, 320, 330, and 340 includes a set of peaks and valleys, where each peak represents a transmission by the central node, and each valley represents a transmission by the peripheral node. Timing diagram 300 shows alternating transmission by each node, but in some examples, a node may be configured to transmit two consecutive packets without the other node transmitting an intervening packet.

The technical standard may support early termination of each connection event, meaning that either of the nodes may terminate the exchange of packets in connection event 310, 320, 330, or 340, after which no communication will occur until the beginning of the next connection event. For example, timing diagram 300 depicts a sub-interval of ceased communication in connection event 310 after the nodes exchange two packets. The technical standard may require that the duration of each of connection events 310, 320, 330, and 340 be a fixed length or less than a preset maximum length.

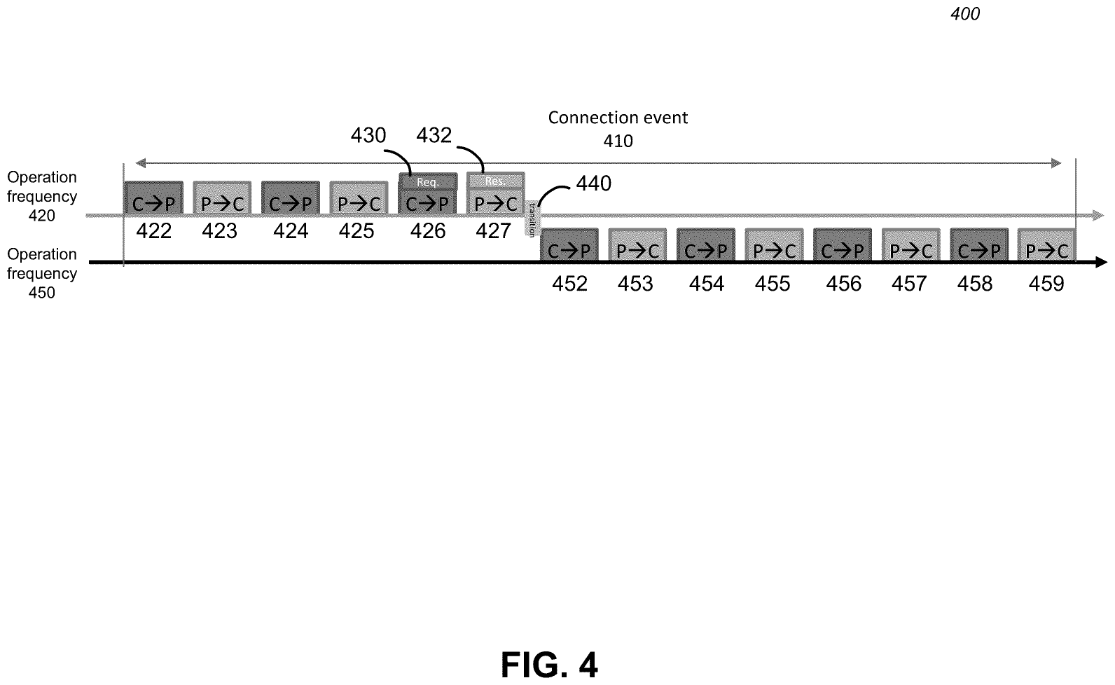

FIGS. 4-8 are timing diagrams 400, 500, 600, 700, and 800 that include a request to change the operation frequency during a connection event according to some aspects of the present disclosure. Each of timing diagrams 400, 500, 600, 700, and 800 show the exchange of packets encoded in two different operation frequencies during a single connection event. In each of timing diagrams 400, 500, 600, 700, and 800, a node issues a request to change the operation frequency, and the nodes transfer to a new operation frequency inside of a connection event.

Timing diagram 400 shows the communication between a central node and a peripheral node during connection event 410. During connection event 410, the nodes exchange packets 422-427 encoded in operation frequency 420. During this exchange, the central node transmits packet 426 to the peripheral node with request 430 to change operation frequency. The peripheral node then transmits packet 427 to the central node with response 432, which is responsive to request 430. Request 430 and/or response 432 may include data such as the new operation frequency for communication (e.g., operation frequency 450) and/or the time to switch, transfer, or transition to the new operation frequency (e.g., the timing of transition 440).

After the peripheral node transmits packet 427, the nodes perform transition 440 from operation frequency 420 to operation frequency 450. Transition 440 occurs without the central node sending any more packets after request 430 and without the peripheral node sending any more packets after response 432. After the nodes perform transition 440, the central node transmits packet 452 to the peripheral node. The nodes exchange packets 452-459 encoded in operation frequency 450 after transition 440. The exchange of packets 452-459 occurs after transition 440 to operation frequency 450 but before the end of connection event 410. Thus, the nodes exchange packets 422-427 and 452-459 at two different operation frequency 420 and 450 during a single connection event 410.

The central node may be configured to perform transition 440 by encoding packets 452, 454, 456, and 458 on signals in operation frequency 450, rather than on signals in operation frequency 420. The central node may be configured to thereafter listen to the channel for operation frequency 450, where packets 453, 455, 457, and 459 are encoded. The peripheral node may be configured to perform transition 440 by listening to the channel for operation frequency 450, where packets 452, 454, 456, and 458 are encoded. The peripheral node may be configured to thereafter encode packets 453, 455, 457, and 459 on signals in operation frequency 450.

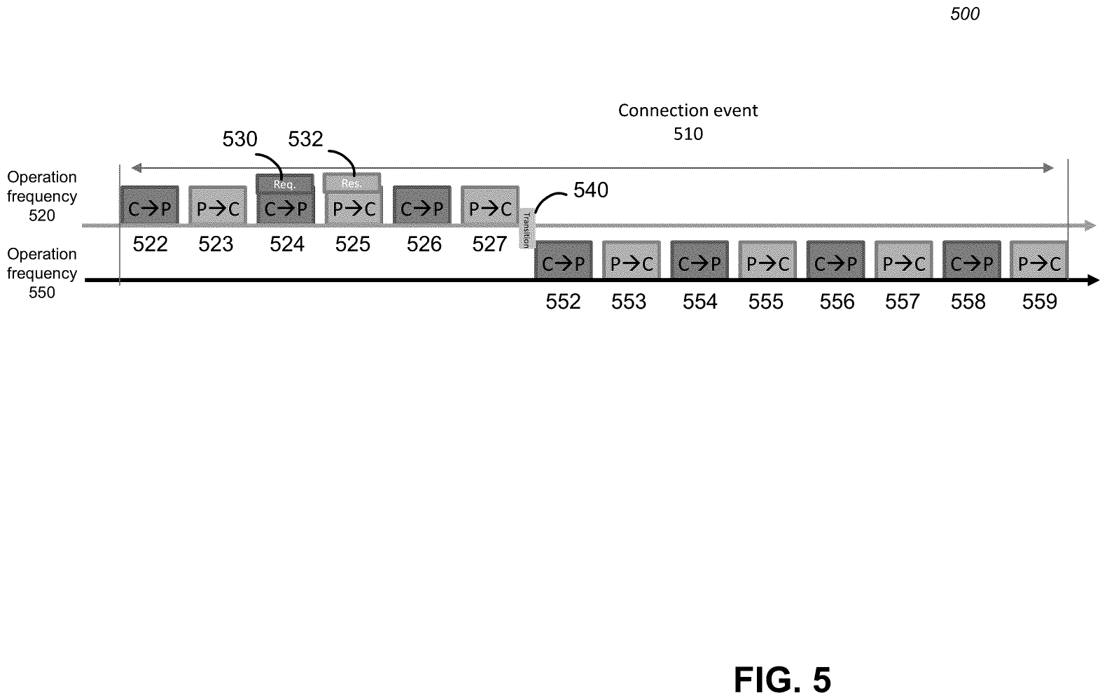

Although timing diagram 400 shows transition 440 occurring immediately after the nodes exchange request 430 and response 432, the transition to a new operation frequency may occur later in the connection event. In other words, the nodes may perform transition 440 immediately after the peripheral node sends response 432, or the nodes may schedule a delay in the transition, as discussed below with respect to FIG. 5. Timing diagram 500 depicts a delay in transition 540 after request 530 and response 532, as compared to transition 440 shown in timing diagram 400, which occurs immediately after response 432. The nodes may schedule the duration of the delay from request 530 and response 532 to transition 540. For example, the central node may be configured to propose a delay in request 530, and the peripheral node may be configured to accept the proposed delay in response 532. The central node may propose the delay by adding a timestamp for transition 540 to request 530, where the timestamp indicates a timing for transition 540 to occur.

During connection event 510, the nodes exchange packets 522-527 encoded in operation frequency 520. During this exchange, the central node transmits packet 524 to the peripheral node with request 530 to change operation frequency. The peripheral node then transmits packet 525 to the central node with response 532, which is responsive to request 530. Request 530 and/or response 532 may include data such as the new operation frequency for communication (e.g., operation frequency 550).

After the peripheral node transmits packet 527, the nodes perform transition 540 from operation frequency 520 to operation frequency 550. After the nodes perform transition 540, the central node transmits packet 552 to the peripheral node. The nodes exchange packets 552-559 encoded in operation frequency 550 after transition 540. The exchange of packets 552-559 occurs after transition 540 to operation frequency 550 but before the end of connection event 510. Thus, the nodes exchange packets 522-527 and 552-559 at two different operation frequencies 520 and 550 during a single connection event 510.

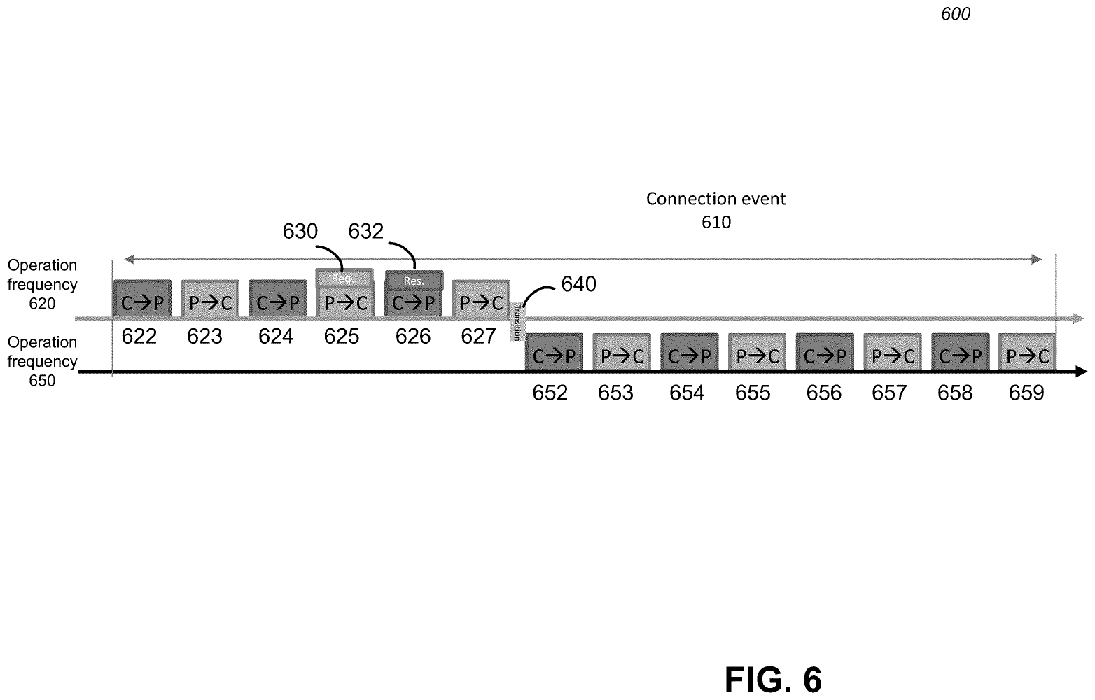

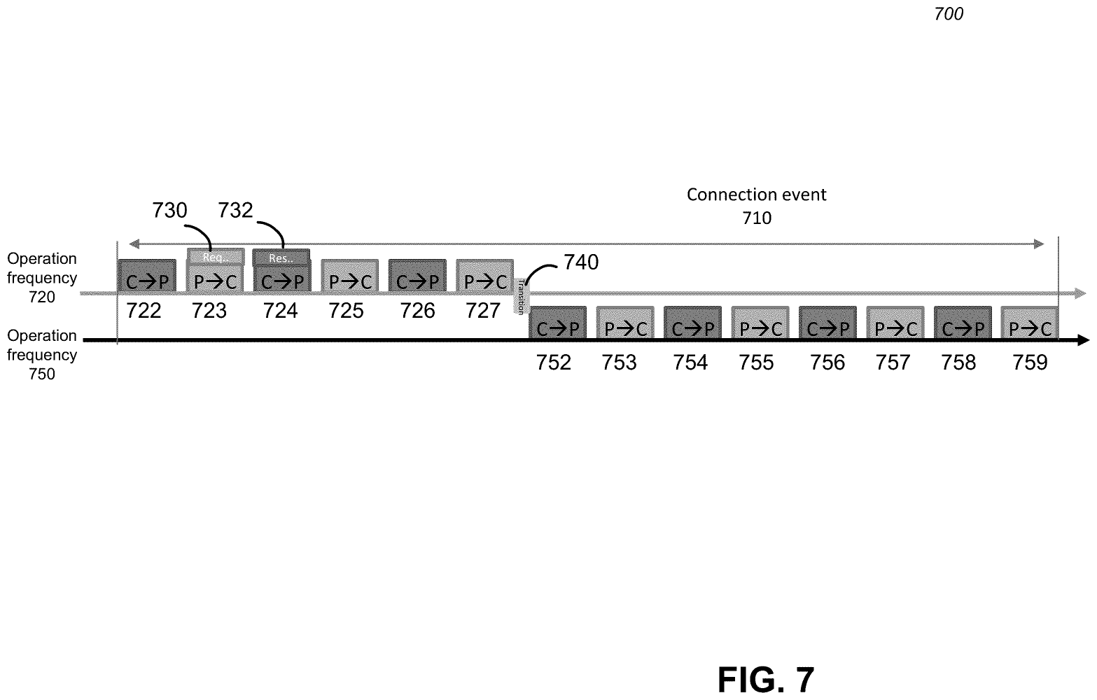

Although timing diagrams 400 and 500 show the central node issuing requests 430 and 530, the peripheral node may be configured to issue a request to change operation frequency, as shown in FIGS. 6 and 7. Timing diagram 600 shown in FIG. 6 shows the peripheral node issuing request 630 and the central node issuing response 632. Thus, in examples shown in FIGS. 4-8, either or both of the nodes may be configured to issue a request to change operation frequency.

During connection event 610, the nodes exchange packets 622-627 encoded in operation frequency 620. During this exchange, the peripheral node transmits packet 625 to the central node with request 630 to change operation frequency. The central node then transmits packet 626 to the peripheral node with response 632, which is responsive request 630. Request 630 and/or response 632 may include data such as the new operation frequency for communication (e.g., operation frequency 650).

The nodes perform transition 640 immediately after request 630 and response 632, except that the nodes wait until just before the central node transmits packet 652. In other words, transition 640 occurs at the next transmission by the central node (i.e., packet 652). The nodes may be configured to wait to perform transition 640 until just before a transmission by the central node so that the transmission in operation frequency 650 is initiated by the central node. Thus, transition 640 occurs without the central node sending any more packets after response 632 and with the peripheral node sending only more packet (e.g., packet 627). This approach may be similar to a technical standard that requires the central node to initiate the communication in each connection event, except that packet 652 is not the beginning of a connection event but rather the first packet encoded in operation frequency 650. Although not shown in any of FIGS. 4-8, the nodes may be configured to perform a transition immediately after a request or response (e.g., the peripheral node will transmit the first packet in the new operation frequency), rather than waiting for the next transmission by the central node.

After the peripheral node transmits packet 627, the nodes perform transition 640 from operation frequency 620 to operation frequency 650, and the nodes exchange packets 652-659 encoded in operation frequency 650 after transition 640. The exchange of packets 652-659 occurs after transition 640 to operation frequency 650 but before the end of connection event 610. Thus, the nodes exchange packets 622-627 and 652-659 at two different operation frequencies 620 and 650 during a single connection event 610.

Timing diagram 700 shown in FIG. 7 depicts a delay in transition 740 after request 730 and response 732, as compared to transition 640 shown in timing diagram 600, which occurs the next transmission by the central node after response 632. The nodes may schedule the duration of the delay from request 730 and response 732 to transition 740. For example, the peripheral node may be configured to propose a delay in request 730, and the central node may be configured to accept the proposed delay in response 732. The peripheral node may be configured to propose the delay by adding a timestamp for transition 740 in request 730, where the timestamp indicates the timing of transition 740 to occur.

During connection event 710, the nodes exchange packets 722-727 encoded in operation frequency 720. During this exchange, the peripheral node transmits packet 723 to the central node with request 730 to change frequencies. The central node then transmits packet 724 to the peripheral node with response 732, which is responsive to request 730. Request 730 and/or response 732 may include data such as the new operation frequency for communication (e.g., operation frequency 750) and the timing of transition 740.

After the peripheral node transmits packet 727, the nodes perform transition 740 from operation frequency 720 to operation frequency 750, and the nodes exchange packets 752-759 encoded in operation frequency 750 after transition 740. The exchange of packets 752-759 occurs after transition 740 to operation frequency 750 but before the end of connection event 710. Thus, the nodes exchange packets 722-727 and 752-759 at two different operation frequencies 720 and 750 during a single connection event 710.

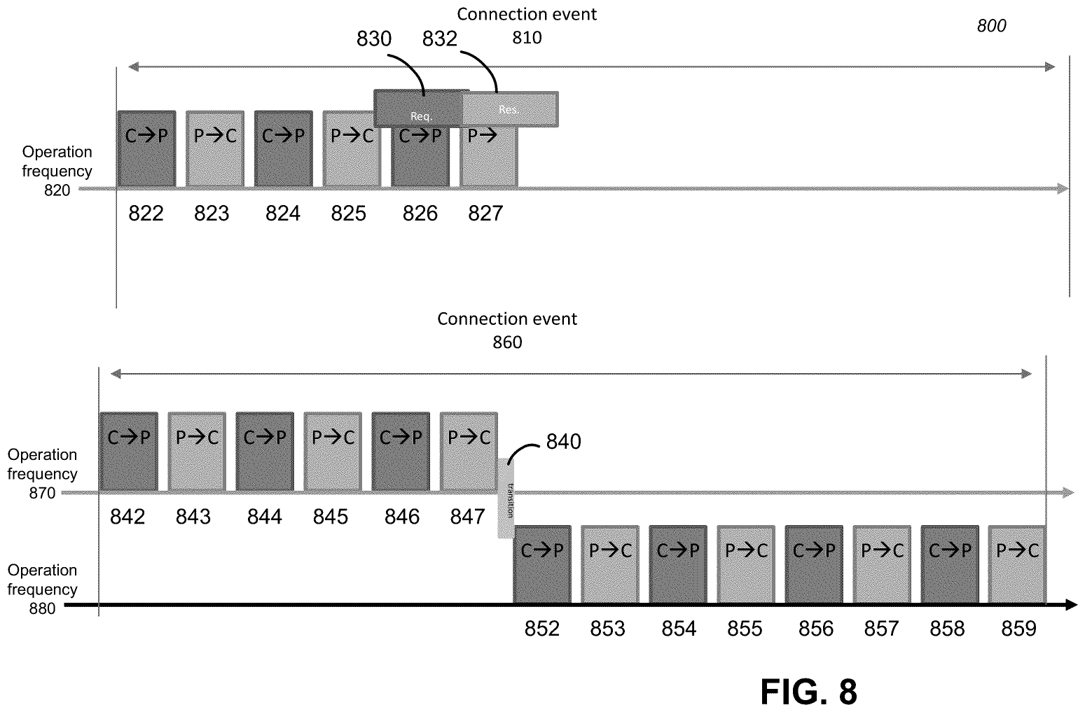

Timing diagrams 400, 500, 600, 700 shows transitions to new operation frequency that occur during the same connection events as the request to transition. For example, the central node issues request 430 during connection event 410, and the nodes perform transition during the same connection event 410. In contrast, timing diagram 800 shown in FIG. 8 shows transition 840 occurring during a later connection event 860 after the conclusion of connection event 810 when a node issued request 830 to change operation frequency. Connection events 810 and 860 may be consecutive events, or there may be one or more events between connection events 810 and 860.

During connection event 810, the nodes exchange packets 822-827 encoded in operation frequency 820. During this exchange, the central node transmits packet 826 to the peripheral node with request 830 to change operation frequency. The peripheral node then transmits packet 827 to the central node with response 832, which is responsive to request 830. Request 830 and/or response 832 may include data such as the new operation frequency for communication (e.g., operation frequency 880) and the timing of transition 840.

Even though the nodes exchanged request 830 and response 832, connection event 810 ends without a transition to a new operation frequency. This is because the nodes scheduled transition 840 to occur during connection event 860. The nodes can schedule the timing of transition 840 using request 830 and/or response 832. After packet 827, the nodes cease communication for the remainder of connection event 810 until connection event 860 begins.

During connection event 860, the nodes exchange packets 842-847 encoded in operation frequency 870. After exchanging packets 842-847, the nodes perform transition 840 from operation frequency 870 to operation frequency 880 based on the schedule established in request 830 and/or response 832. After transition 840, the nodes then exchange packets 852-859 encoded in operation frequency 880. The exchange of packets 852-859 occurs after transition 840 to operation frequency 880 but before the end of connection event 860. Thus, the nodes exchange packets 842-847 and 852-859 at two different operation frequencies 870 and 880 during a single connection event 860.

After changing operation frequency, the nodes may exchange packets 852-859 for the remainder of connection event 860. However, packets 842-847 exchanged before transition 840 may not have been received by the non-transmitting node. For that reason, it may be beneficial for the nodes to extend the duration of connection event 860 to allow for additional communication before having to start a new connection event. Connection event 860 may have a preset duration and/or a maximum duration that have been established in the technical standard. After transition 840, the remaining duration of connection event 860 may not be sufficient for the nodes to conclude their communication.

If a node determines that there is not sufficient time remaining in connection event 860 to exchange information, that node can request an extension to the duration of connection event 860. In other words, each node may be configured to send a request extend the duration of connection event 860 or to extend the duration of any other connection event. The node can send this request during connection event 860 or during connection event 810. For example, the central node can send the request to extend the duration of connection event 860 along with request 830 to change operation frequency. Alternatively, the peripheral node may issue the request to extend the duration of connection event 860 even though the central node issued request 830 to change operation frequency.

Although requests to extend the duration of a connection event have been described in the context of changing operation frequency, a node may be configured to request an extension of the duration of a connection event regardless of whether either node has requested a change in operation frequency. Even without any request to change operation frequency, a node may be configured to request an extension in the duration of the connection event. The node may request that the duration be extended beyond the present duration and/or beyond the maximum duration set by the technical standard. The extension may allow for the nodes to achieve higher throughput by postponing the end of the connection event.

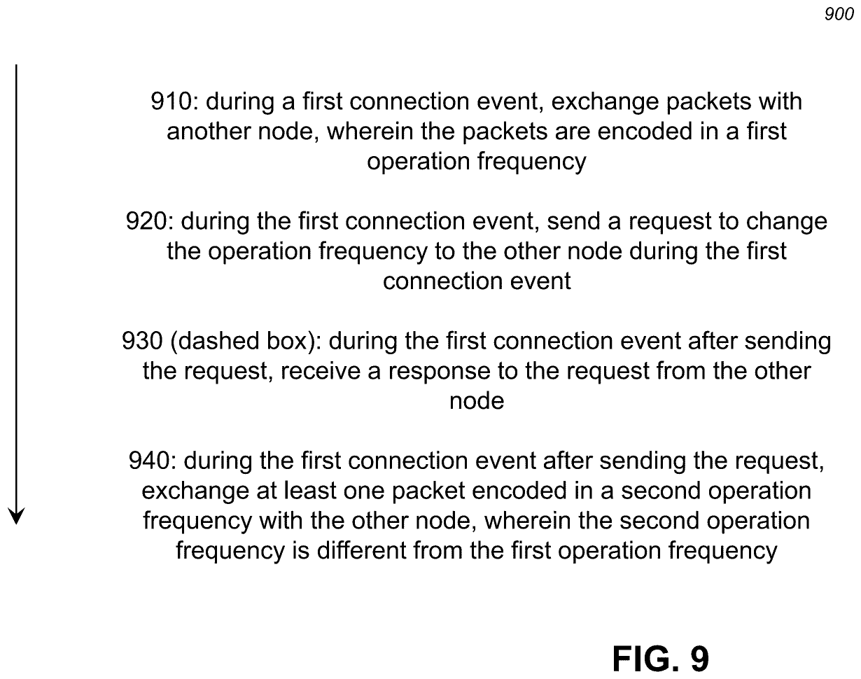

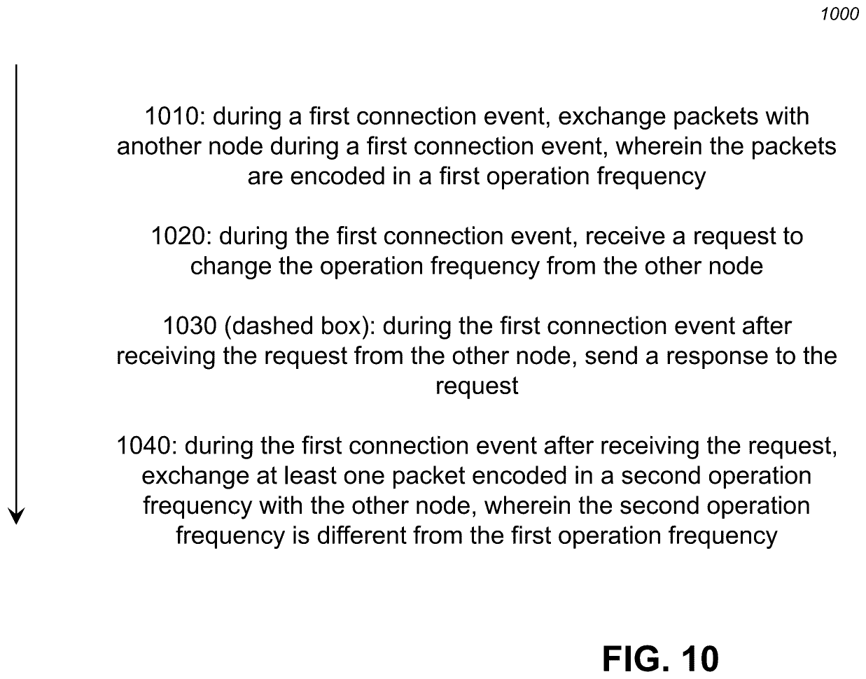

FIGS. 9 and 10 are flow diagrams of methods 900 and 1000 of changing operation frequency during a connection event according to some aspects of the present disclosure. Some processes of the methods 900 and 1000 may be performed in orders other than described, and many processes may be performed concurrently in parallel. Furthermore, processes of the methods 900 and 1000 may be omitted or substituted in some examples of the present disclosure. The methods 900 and 1000 are described with reference to central node 110 shown in FIG. 1, although other components such as peripheral node 150 shown in FIG. 1 may exemplify similar techniques.

Referring to block 910, central node 110 exchanges packets encoded in a first operation frequency with peripheral node 150 during a first connection event. To exchange packets, each of processing circuitry 140 and 180 can generate packets and cause transceiver circuitry 130 and 170 to transmit the packets via antennas 120 and 160. The first operation frequency may be the default operation frequency for the first connection event. For example, nodes 110 and 150 may be configured to select the first operation frequency based on the pre-defined channel set, based on negotiation between nodes 110 and 150, and/or based on some other criteria. However, nodes 110 and 150 may experience noise, jamming, and/or interference on the first operation frequency. As a result, nodes 110 and 150 may drop one or more of the packets exchanged on the first operation frequency.

Referring to block 920, central node 110 sends a request to change the operation frequency to peripheral node 150 during the first connection event. Processing circuitry 140 can embed the request to change the operation frequency within one of the packets sent by transceiver circuitry 130. Additionally or alternatively, processing circuitry 140 may be configured to generate the request to change the operation frequency as a message separate from other packets sent by transceiver circuitry 130. In some examples, central node 110 may send the request to change the operation frequency in method 900, 1000, 1100, or 1200 along with a request to extend the duration of the connection event.

The request may include an indication of one or more parameters, such as the new operation frequency and the timing for the transition to the new operation frequency. As an alternative to negotiating the new operation frequency, nodes 110 and 150 may determine the new operation frequency based on a channel set. Each of nodes 110 and 150 may store the pre-defined channel set in an onboard memory.

The request in block 920 is a fast means of signaling a change in operation frequency for nodes 110 and 150, as compared to waiting for the next connection event to begin. For example, using a request to change the operation frequency, it may be less than one millisecond to change the operation frequency (e.g., three hundred microseconds). In contrast, waiting for the next connection event may take more than one millisecond (e.g., two or three milliseconds).

Referring to block 930, central node 110 optionally receives a response from peripheral node 150 during the first connection event after sending the request to change the operation frequency. Processing circuitry 180 may generate the response to confirm that peripheral node 150 received the request to change the operation frequency. Through the response, peripheral node 150 may confirm the new operation frequency and/or confirm the timing of the transition to the new operation frequency. In the response, processing circuitry 180 may be configured to request renegotiation of the frequency transition and/or place a restriction on the transition, such as a restriction on the new operation frequency or the timing of the transition. Processing circuitry 180 can cause transceiver circuitry 170 to send the response as part of a packet in the exchange between nodes 110 and 150.

Referring to block 940, central node 110 exchanges at least one packet encoded in a second operation frequency with peripheral node 150, where the second operation frequency is different from the first operation frequency. Nodes 110 and 150 exchange the at least one packet after transferring to the second operation frequency and before the end of the first connection event. Thus, nodes 110 and 150 use two different operation frequencies during the first connection event. The second operation frequency may have less noise, jamming, and/or interference, allowing for a reduced error rate in the communication between nodes 110 and 150.

In method 900, central node 110 issued the request to change the operation frequency. However, peripheral node 150 may also be capable of issuing a request to change the operation frequency. Referring to block 1010, central node 110 exchanges packets encoded in a first operation frequency with peripheral node 150 during a first connection event. Referring to block 1020, central node 110 receives a request to change the operation frequency from peripheral node 150 during the first connection event. Peripheral node 150 may send the request to change the operation frequency embedded within one of the packets exchanged between nodes 110 and 150. Additionally or alternatively, peripheral node 150 may be configured to send the request to change the operation frequency as message separate from other packets exchanged by nodes 110 and 150. The request may include a first indication of new operation frequency and/or a second indication of the timing for the transition to the new operation frequency.

Referring to block 1030, central node 110 optionally sends a response to peripheral node 150 during the first connection event after receiving the request to change the operation frequency. Processing circuitry 140 may cause transceiver circuitry 130 to send the response to confirm that central node 110 received the request to change the operation frequency. Through the response, central node 110 may confirm the new operation frequency and/or confirm the timing of the transition to the new operation frequency. Central node 110 can send the response as part of a packet in the exchange between nodes 110 and 150.

Referring to block 1040, central node 110 exchanges at least one packet encoded in a second operation frequency with peripheral node 150, where the second operation frequency is different from the first operation frequency. Nodes 110 and 150 exchange the at least one packet after transferring to the second operation frequency and before the end of the first connection event. Thus, nodes 110 and 150 use two different operation frequency during the first connection event. The second operation frequency may have less noise, jamming, and/or interference, allowing for a reduced error rate in the communication between nodes 110 and 150.

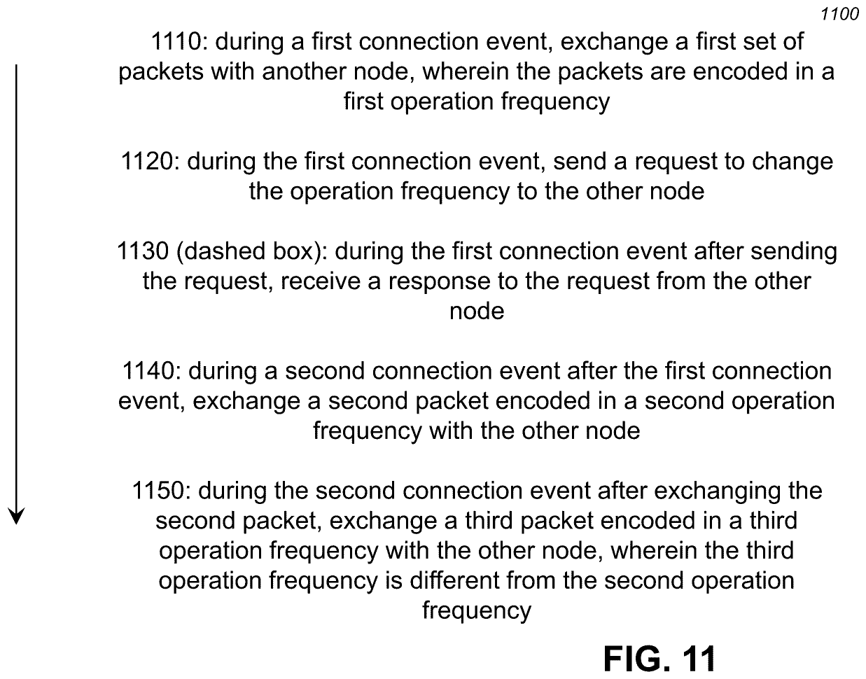

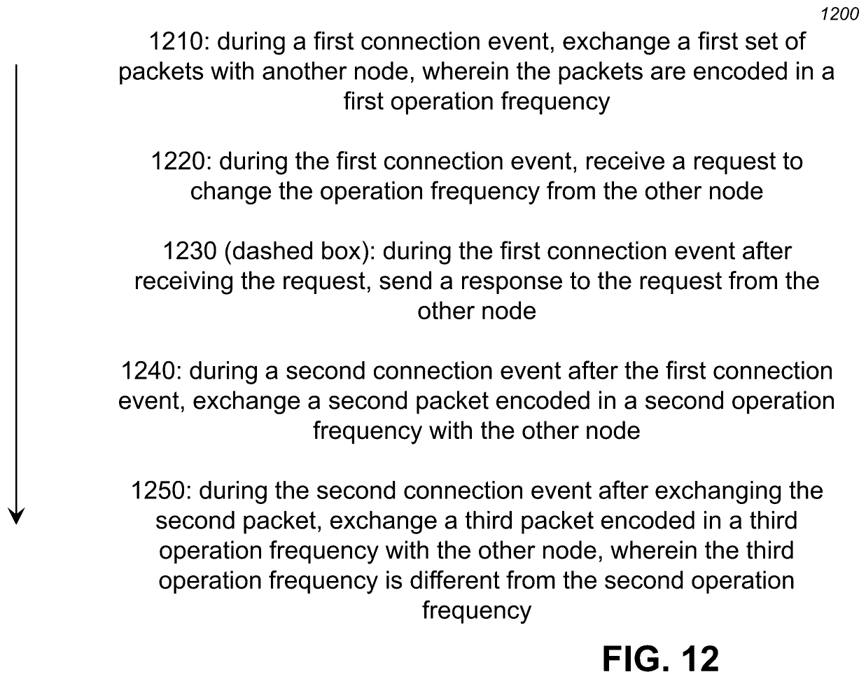

Methods 900 and 1000 involve transferring to a new operation frequency during the same connection event as the request to change the operation frequency. However, the nodes may schedule a transition to a new operation frequency in a later connection event. In that regard, FIGS. 11 and 12 are flow diagrams of methods 1100 and 1200 of scheduling a transition to new operation frequency in a subsequent connection event according to some aspects of the present disclosure. Some processes of the methods 1100 and 1200 may be performed in orders other than described, and many processes may be performed concurrently in parallel. Furthermore, processes of the methods 1100 and 1200 may be omitted or substituted in some examples of the present disclosure. The methods 1100 and 1200 are described with reference to central node 110 shown in FIG. 1, although other components such as peripheral node 150 shown in FIG. 1 may exemplify similar techniques.

Referring to block 1110, central node 110 exchanges a first set of packets encoded in a first operation frequency with peripheral node 150 during a first connection event. Referring to block 1120, processing circuitry 140 causes transceiver circuitry 130 to send a request to change the operation frequency to peripheral node 150 during the first connection event. Central node 110 may send the request to change the operation frequency embedded within one of the packets in the first set of packets. Additionally or alternatively, central node 110 may be configured to send the request to change the operation frequency as message separate from the first set of packets. The request may include a first indication of new operation frequency and/or a second indication of the timing for the transition to the new operation frequency during a later connection event.

Referring to block 1130, central node 110 optionally receives a response from peripheral node 150 during the first connection event after sending the request to change the operation frequency. Peripheral node 150 may send the response to confirm that peripheral node 150 received the request to change the operation frequency. Through the response, peripheral node 150 may confirm the new operation frequency and/or confirm the timing of the transition to the new operation frequency. Peripheral node 150 may send the response as part of a packet in the first set of packets. By exchange the request and response, nodes 110 and 150 can preemptively negotiate a channel transition that nodes 110 and 150 will apply in a later connection event.

Referring to block 1140, central node 110 exchanges a second packet encoded in a second operation frequency with peripheral node 150, where the second operation frequency is different from the first operation frequency. Nodes 110 and 150 exchange the second packet in a second connection event that is subsequent to the first connection event. The second packet may be part of a second set of packets exchanged between nodes 110 and 150 at the beginning of the second connection event (e.g., packets 842-847 shown in FIG. 8).

Referring to block 1150, central node 110 exchanges a third packet encoded in a third operation frequency with peripheral node 150, where the third operation frequency is different from the second operation frequency. The third operation frequency may also be different from the first operation frequency used by nodes 110 and 150 during the first connection event. Nodes 110 and 150 exchange the third packet after transferring to the third operation frequency and before the end of the second connection event. Thus, nodes 110 and 150 use two different operation frequencies during the second connection event.

In method 1100, central node 110 issued the request to change the operation frequency in a later connection event. However, peripheral node 150 may also be capable of issuing a request to change the operation frequency in a later connection event. Referring to block 1210, central node 110 exchanges a first set of packets encoded in a first operation frequency with peripheral node 150 during a first connection event. Referring to block 1220, central node 110 receives a request to change the operation frequency from peripheral node 150 during the first connection event. Peripheral node 150 may send the request to change the operation frequency embedded within one of the packets in the first set of packets. Additionally or alternatively, peripheral node 150 may be configured to send the request to change the operation frequency as message separate from the first set of packets. The request may include a first indication of new operation frequency and/or a second indication of the timing for the transition to the new operation frequency during a later connection event.

Referring to block 1230, central node 110 optionally sends a response to peripheral node 150 during the first connection event after receiving the request to change the operation frequency. Central node 110 may send the response to confirm that central node 110 received the request to change the operation frequency. Through the response, central node 110 may confirm the new operation frequency and/or confirm the timing of the transition to the new operation frequency. Central node 110 can send the response as part of a packet in the first set of packets.

Referring to block 1240, central node 110 exchanges a second packet encoded in a second operation frequency with peripheral node 150, where the second operation frequency is different from the first operation frequency. Nodes 110 and 150 exchange the second packet in a second connection event that is subsequent to the first connection event. The second packet may be part of a second set of packets exchanged between nodes 110 and 150 at the beginning of the second connection event (e.g., packets 842-847 shown in FIG. 8).

Referring to block 1250, central node 110 exchanges a third packet encoded in a third operation frequency with peripheral node 150, where the third operation frequency is different from the second operation frequency. The third operation frequency may also be different from the first operation frequency used by nodes 110 and 150 during the first connection event. Nodes 110 and 150 exchange the third packet after transferring to the third operation frequency and before the end of the second connection event. Thus, nodes 110 and 150 use two different operation frequencies during the second connection event.

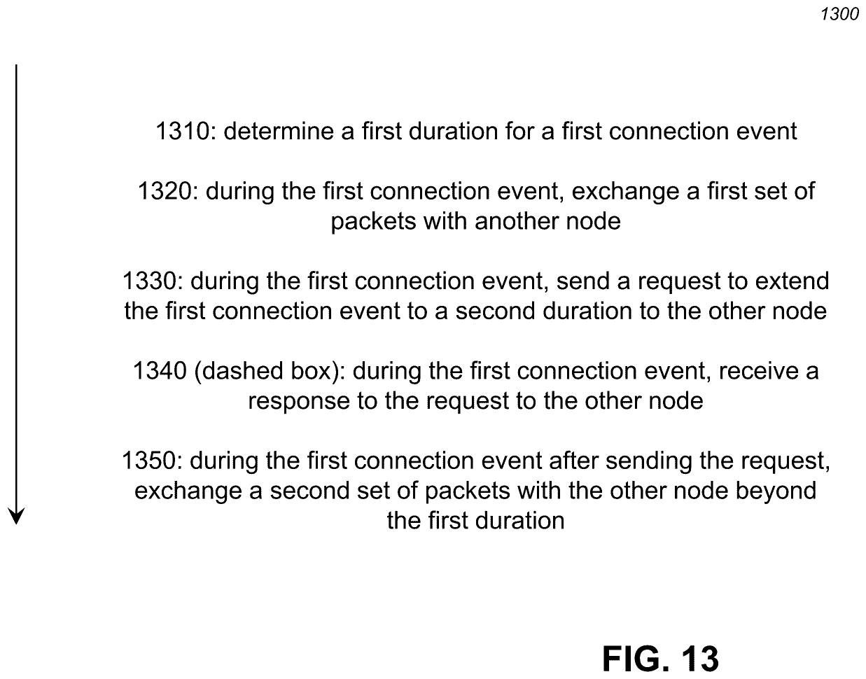

FIG. 13 is a flow diagram of method 1300 of extending the duration of a connection event according to some aspects of the present disclosure. Some processes of the method 1300 may be performed in orders other than described, and many processes may be performed concurrently in parallel. Furthermore, processes of the method 1300 may be omitted or substituted in some examples of the present disclosure. The method 1300 is described with reference to central node 110 shown in FIG. 1, although other components such as peripheral node 150 shown in FIG. 1 may exemplify similar techniques.

Referring to block 1310, central node 110 determines a first duration for a first connection event. The first duration may be a default duration, a preset duration, and/or a maximum duration. Central node 110 may be configured to determine the first duration based on a technical standard. For example, software or firmware stored in memory onboard central node 110 may include a data value for the first duration.

Referring to block 1320, central node 110 exchanges a first set of packets with peripheral node 150 during the first connection event. Nodes 110 and 150 may begin exchanging the first set of packets at the beginning of the first connection event. Referring to block 1330, central node 110 sends a request to extend the first connection event to a second duration to peripheral node 150. Central node 110 may embed the request within one of the packets in the first set of packets. Additionally or alternatively, central node 110 may be configured to send the request as message separate from other packets in the first set of packets.

Referring to block 1340, central node 110 optionally receives a response from peripheral node 150 during the first connection event after sending the request. Peripheral node 150 may send the response to confirm that peripheral node 150 received the request to extend the duration of the first connection event. Through the response, peripheral node 150 may confirm the new duration. Peripheral node 150 can send the response as part of a packet in the first set of packets or as a message separate from the first set of packets.

Referring to block 1350, central node 110 exchanges a second set of packets with peripheral node 150 during the first connection event after sending the request to extend the duration of the first connection event. The exchange of the second set of packets may continue beyond the first duration of the first connection event. Thus, the actual duration of the first connection event (e.g., the second duration) may be longer than the preset default duration and/or longer than the preset maximum duration. In other words, nodes 110 and 150 may continue exchanging packets beyond the first duration without terminating the first connection event or setting up a second connection event.

The longer duration may allow for increased throughput during the first connection event without the overhead of terminating the first connection event and initiating a second connection event thereafter. As noted above, although methods 900, 1000, 1100, 1200, and 1300 have been described as being performed by central node 110, peripheral node 150 may also be configured to perform methods 900, 1000, 1100, 1200, and/or 1300.

This disclosure has attributed functionality to nodes 110 and 150. Nodes 110 and 150, transceiver circuitry 130 and 170, and processing circuitry 140 and 180 may include one or more processors. Nodes 110 and 150, transceiver circuitry 130 and 170, and processing circuitry 140 and 180 may include any combination of integrated circuitry, discrete logic circuitry, analog circuitry, such as one or more microprocessors, microcontrollers, digital signal processors, application specific integrated circuits, central processing units, graphics processing units, field-programmable gate arrays, and/or any other processing resources.

In some examples, nodes 110 and 150, transceiver circuitry 130 and 170, and processing circuitry 140 and 180 may include multiple components, such as any combination of the processing resources listed above, as well as other discrete or integrated logic circuitry, and/or analog circuitry.

The techniques described in this disclosure may also be embodied or encoded in an article of manufacture including a non-transitory computer-readable storage medium. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

It is understood that the present disclosure provides a number of exemplary embodiments and that modifications are possible to these embodiments. Such modifications are expressly within the scope of this disclosure. Furthermore, application of these teachings to other environments, applications, and/or purposes is consistent with and contemplated by the present disclosure.

What is claimed is:

1. A method comprising:
sending, by a first node to a second node during a first connection event, a request to change a current operation frequency, wherein the request is encoded in a first operation frequency; and
sending, by the first node to the second node during the first connection event, a first packet encoded in a second operation frequency,
wherein the second operation frequency is different from the first operation frequency.

2. The method of claim 1, further comprising receiving, at the first node from the second node during the first connection event, a response to the request, wherein the response is encoded in the first operation frequency.

3. The method of claim 1, wherein the request is a first request, the method further comprising sending, by the first node to the second node during the first connection event, a second request to extend a duration of the first connection event.

4. The method of claim 3, further comprising, after sending the second request, exchanging packets between the first and second nodes during the first connection event beyond a preset duration of the first connection event.

5. The method of claim 1, wherein the request is a first request, the method further comprising receiving, by the first node from the second node during the first connection event, a second request to extend a duration of the first connection event.

6. The method of claim 1, wherein the first node sends no other packets encoded in the first operation frequency during the first connection event after sending the request.

7. The method of claim 1, wherein the first node sends only one other packet encoded in the first operation frequency during the first connection event after sending the request.

8. The method of claim 1, further comprising generating the request to include an indication of a time for the first and second node to change the current operation frequency,
wherein sending the first packet occurs after the time to change the current operation frequency.

9. The method of claim 1, further comprising:
generating a second packet before sending the request; and
embedding the request in the second packet,
wherein sending the request comprises sending the second packet and the embedded request to the peripheral node during the first connection event.

10. The method of claim 1, wherein the first connection event is a Bluetooth Low Energy connection event.

11. The method of claim 1, wherein sending the first packet occurs before an end of the first connection event.

12. The method of claim 1, further comprising generating the request to include an indication of the second operation frequency.

13. The method of claim 1, further comprising determining the second operation frequency based on a pre-defined channel set.

14. A device comprising:
transceiver circuitry; and
processing circuitry configured to:
generate a request to change a current operation frequency during a first connection event;
cause the transceiver circuitry to send the request encoded in a first operation frequency;
generate a first packet after causing the transceiver circuitry to send the request; and
cause the transceiver circuitry to send, during the first connection event, the first packet encoded in a second operation frequency,
wherein the second operation frequency is different from the first operation frequency.

15. The device of claim 14,
wherein the request is a first request, and
wherein the processing circuitry is further configured to cause the transceiver circuitry to send, during the first connection event, a second request to extend a duration of the first connection event.

16. The device of claim 14,
wherein the processing circuitry is further configured to generate the request to include an indication of a time for the first and second node to change the current operation frequency, and
wherein the processing circuitry is configured to cause the transceiver circuitry to send the first packet after the time to change the current operation frequency.

17. The device of claim 14, wherein the processing circuitry is further configured to generate the request to include an indication of the second operation frequency.

18. A non-transitory computer-readable medium having executable instructions stored thereon, configured to be executable by processing circuitry for causing the processing circuitry to:
generate a request to change a current operation frequency during a first connection event;
cause transceiver circuitry to send the request encoded in a first operation frequency;
generate a first packet after causing the transceiver circuitry to send the request; and
cause the transceiver circuitry to send, during the first connection event, the first packet encoded in a second operation frequency,
wherein the second operation frequency is different from the first operation frequency.

19. The non-transitory computer-readable medium of claim 18,
wherein the request is a first request, and
wherein the instructions are further configured to cause the transceiver circuitry to send, during the first connection event, a second request to extend a duration of the first connection event.

20. The non-transitory computer-readable medium of claim 18,
wherein the instructions are further configured to generate the request to include an indication of a time for the first and second node to change the current operation frequency, and
wherein the instructions to cause the transceiver circuitry to send the first packet occurs after the time to change the current operation frequency.
